(19) United States
(12) Patent Application Publication
(10) Pub. No.: US 2024/0149222 A1
(43) Pub. Date: May 9, 2024

(54) Multi-element membrane separator and separation method based on spiral-wound membrane elements

(71) Applicant: Tianjin University, Tianjin (CN)

(72) Inventors: Zhi Wang, Tianjin (CN); Qinghua Li, Tianjin (CN); Hongyu Wu, Tianjin (CN); Jixiao Wang, Tianjin (CN); Song Zhao, Tianjin (CN)

(21) Appl. No.: 18/502,200

(22) Filed: Nov. 6, 2023

(30) Foreign Application Priority Data
Nov. 7, 2022 (CN) 2022113840878

(51) Int. Cl. B01D 63/12; B01D 53/22

(52) U.S. Cl. CPC B01D 63/12; B01D 53/227; B01D 53/228; B01D 2053/221; B01D 2257/504; B01D 2258/0283; B01D 2313/143; B01D 2313/146; B01D 2313/21

(57) ABSTRACT

This invention relates to a multi-element membrane separator and separation method based on spiral-wound membrane elements. It includes a membrane housing, spiral-wound membrane elements, and baffles on both sides of the membrane housing, designed to secure the spiral-wound membrane elements. The permeate tubes of the spiral-wound membrane elements are connected to the openings in the perforated plates. Sealing rings are respectively provided at the connections of the permeate tubes and the perforated plate openings. This multi-element membrane separator enables a more compact arrangement of membrane elements, reducing the footprint of the membrane separation device. It also reduces the use of materials such as membrane housing, pipelines, and connecting fittings, thereby lowering equipment costs and the difficulty of membrane device assembly.

### TECHNICAL FIELD

This invention pertains to a multi-element membrane separator and separation method based on spiral-wound membrane elements, particularly targeting gas separation, specifically in the field of CO2 separation.

### BACKGROUND

Carbon capture utilization and storage (CCUS) technology is a crucial technology that can significantly reduce carbon emissions from fossil fuel combustion in power generation and industrial processes. Its developmental vision is to construct a low-cost, low-energy, safe, and reliable CCUS technology system and industrial cluster. Among various CO2 capture technologies, membrane separation technology has garnered increasing attention in recent years due to its advantages such as low energy consumption, high reliability, absence of secondary pollution, and flexible processing scale.

The design and large-scale preparation of membrane separators with high packing density, low pressure loss, and low manufacturing costs are crucial for the application of membrane separation technology. Currently, commonly used industrial membrane separators include plate-and-frame, spiral-wound, and hollow fiber types. Among these, the spiral-wound membrane separator was first developed in the mid-1960s by the American company Gulf General Atomics, with funding from the Office of Saline Water for seawater desalination projects. The flat membrane sheets used in spiral-wound membrane separators are easy to prepare on a large scale continuously and are themselves easily scalable, with advantages such as compact structure and low cost. As a result, they occupy a significant portion of the market and have been widely applied in membrane separation fields such as reverse osmosis and nanofiltration. Compared to plate-and-frame and hollow fiber membrane separators, spiral-wound membrane separators have the most extensive potential for application in gas separation, especially in the field of post-combustion CO2 capture, due to their advantages of higher packing density and lower pressure loss.

A membrane separator is a practical device composed of membrane elements installed within a membrane housing. In industrial applications, the standard specifications for membrane elements are primarily the 4040 element (4.0 inches in diameter, 40 inches in length) and the 8040 element (8.0 inches in diameter, 40 inches in length), with an effective membrane area of about 10 to 40 m2. In contrast, constructing an industrial membrane separation facility requires thousands or even millions of square meters of separation membranes, meaning hundreds or even thousands of membrane separators are needed. FIG. 1 shows a schematic cross-sectional structure of a conventional membrane separator and a schematic diagram of the membrane separator connection. The membrane separator is equipped with a feed gas interface, a retentate gas interface, and a permeate gas interface, with only one membrane element contained within the membrane housing. In the membrane separation system, the feed gas interface, retentate gas interface, and permeate gas interface of each membrane separator are respectively connected to the feed gas manifold, retentate gas manifold, and permeate gas manifold through connecting devices such as clamps. Constructing a membrane separation facility using conventional membrane separators that contain only a single membrane element results in a significant waste of membrane housing materials. The combination of connections between membrane separators also leads to numerous connecting pipelines and a complex layout. Meanwhile, to facilitate installation, there is a considerable gap between membrane separators, leading to a lower space utilization rate. Ultimately, this significantly increases equipment investment and floor space, affecting the economic viability and application prospects of membrane technology. Furthermore, there is still relatively limited research and reporting on industrial-scale membrane separators used for gas separation, particularly in CO2 capture, which also limits the widespread application of membrane technology. Therefore, the optimization design of the membrane separator structure and the rational arrangement and combination of internal membrane elements are of significant importance in developing membrane separators with a large membrane area, high packing density, and low pressure loss.

### SUMMARY

The present invention proposes a multi-element membrane separator based on spiral-wound membrane elements, designed to accommodate multiple membrane elements and achieve their efficient combination. The spiral-wound membrane elements in this invention consist of separation membranes, feed-side spacers, permeate-side spacers, and permeate tubes. The multi-element membrane separator of the present invention is a practical device composed of multiple spiral-wound membrane elements, membrane housings, end caps, connectors, and sealing rings. The multi-element membrane separator of the present invention is equipped with a feed gas interface, a retentate gas interface, and a permeate gas interface. The separation process is as follows: the raw gas to be separated flows into the membrane separator from the feed gas interface, then enters the feed channel formed by the feed-side spacer inside the membrane element. Gas components with a fast permeation rate preferentially permeate through the membrane under the driving force of the pressure difference, entering the permeate channel formed by the permeate-side spacer, and then gathering in the perforated permeate tube. Finally, they are collected as permeate gas and flow out of the membrane separator through the permeate gas interface. Gas components with a slower permeation rate mostly do not permeate through the membrane, flowing out from the other side of the feed channel of the membrane element and finally being collected as retentate gas, which flows out of the membrane separator through the retentate gas interface.

The technical solution of the present invention is as follows:

A multi-element membrane separator based on spiral-wound membrane elements, comprising a membrane housing, spiral-wound membrane elements; baffles are provided on both sides inside the membrane housing to fix the spiral-wound membrane elements; at least 3 spiral-wound membrane elements are set inside the membrane housing; the membrane housing can be connected to an end cap or another membrane housing, or connected to a membrane housing with an opening, which is then connected to the end cap; the membrane housing or the membrane housing with an opening is provided with interfaces as a feed gas interface or a retentate gas interface.

There are perforated plates between the membrane housing and the end cap or between the membrane housing with an opening and the end cap; the permeate tubes of the spiral-wound membrane elements are connected to the openings in the perforated plates; the connection parts of the permeate tubes and the perforated plate openings are provided with permeate tube sealing rings and perforated plate sealing rings, respectively.

The ends of the membrane housing, membrane housing with an opening, and end cap of the multi-element membrane separator are provided with flange joints, and the various parts of the membrane separator are detachably connected by flanges, gaskets, and bolts. The spiral-wound membrane element is composed of separation membranes, feed-side spacers, permeate-side spacers, and permeate tubes

The method of the multi-element membrane separator based on spiral-wound membrane elements of the present invention involves the raw gas to be separated flowing into the membrane separator from the feed gas interface, then entering the feed channel formed by the feed-side spacer inside the membrane element. Gas components with a faster permeation rate preferentially permeate through the membrane under the driving force of the pressure difference, entering the permeate channel formed by the permeate-side spacer, and then gathering in the perforated permeate tube. Finally, they are collected as permeate gas and flow out of the membrane separator through the permeate gas interface. Gas components with a slower permeation rate mostly do not permeate through the membrane, flowing out from the other side of the feed channel of the membrane element and finally being collected as retentate gas, which flows out of the membrane separator through the retentate gas interface.

Compared with the membrane separator shown in FIG. 1, the multi-element membrane separator designed in the present invention achieves a more compact arrangement of membrane elements, reducing the footprint of the membrane separation device. The multi-element membrane separator reduces the amount of materials such as membrane housing, pipes, and connecting fittings, thereby reducing equipment costs and the difficulty of membrane equipment assembly. The multi-element membrane separator has the advantages of high separation efficiency and low pressure loss. When the retentate gas pressure and the permeate gas pressure are 0.5 and 0.1 MPa, respectively, it can purify the CO2 content in flue gas to 36.3%-37.0%, with a CO2 recovery rate of up to 66.9%-67.8%. Adjusting the pressure can further increase the CO2 content to 51.0%, and the feed side pressure drop is only 0.004-0.015 MPa, with a negligible impact on operational energy consumption. The present invention can flexibly adjust the number of membrane elements and the number of connections within the membrane housing according to requirements, realizing the modular rapid assembly of membrane separators with a large membrane area. It effectively solves the problems of complex and low space utilization of connecting pipelines in conventional membrane separators, while reducing equipment costs and promoting the application of membrane separation technology in the field of gas separation, especially in CO2 separation.

### BRIEF DESCRIPTION OF THE FIGURES

FIG. 1 is a schematic cross-sectional structural diagram and a schematic diagram of the connection method of a conventional membrane separator.

FIG. 2 is a schematic structural diagram of the spiral wound membrane element of the present invention.

FIG. 3 is a front view of the 7-element membrane separator of the present invention.

FIG. 4 is a top view of the 7-element membrane separator of the present invention.

FIG. 5 is a cross-sectional view of the 7-element membrane separator of the present invention.

FIG. 6 is a front view of the 14-element membrane separator of the present invention.

FIG. 7 is a cross-sectional view of the 14-element membrane separator of the present invention.

FIG. 8 is a cross-sectional view of the 8-element membrane separator of the present invention.

wherein, 1. Permeate gas interface; 2. Perforated plate; 3. Feed gas interface; 4. Baffle; 5. Spiral-wound membrane element; 6. Membrane element sealing ring; 7. Permeate tube sealing ring; 8. Perforated plate sealing ring; 9. Permeate tube-perforated plate connector; 10. End cap; 11. Retentate gas interface; 12. Permeate tube; 13. Membrane housing; 14. Membrane housing with an opening; 15. Permeate tube-permeate tube connector; 16. Feed-side spacer; 17. Permeate-side spacer; 18. Separation membrane.

### DETAILED DESCRIPTION OF THE INVENTION

The present invention will be further described below in conjunction with the accompanying drawings and embodiments.

### Embodiment 1

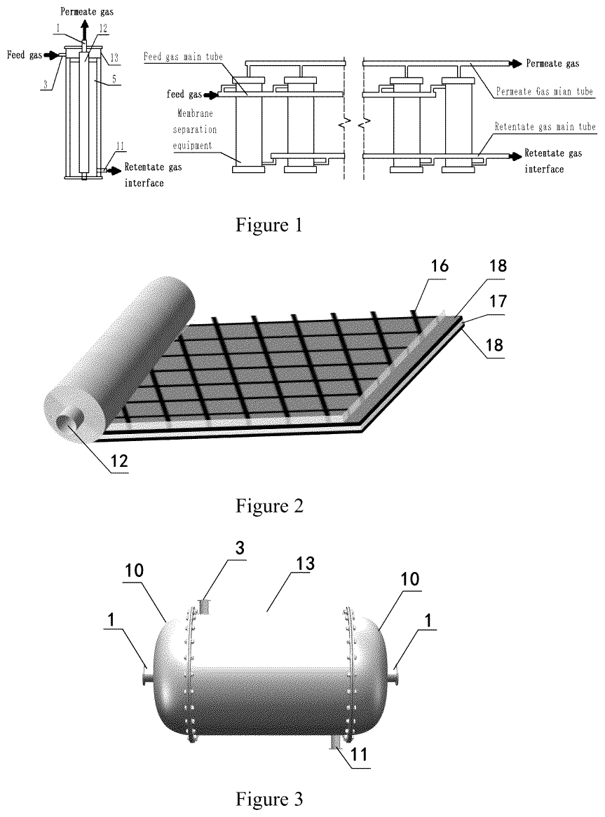

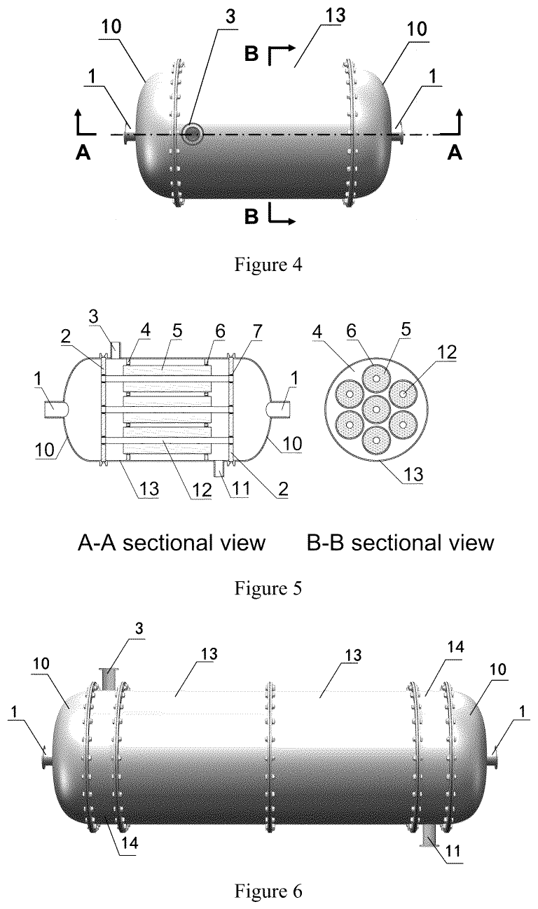

Referring to FIGS. 3 to 5, the multi-element membrane separator based on a spiral-wound membrane element includes a membrane housing (13), a perforated plate (2), and an end cap (10). The membrane housing (13) is equipped with baffles (4) on both sides to secure the spiral-wound membrane element (5). A membrane element sealing ring (6) is placed between the baffles (4) and the spiral-wound membrane element (5) to prevent short-circuiting of the feed gas within the membrane separator and direct entry into the retentate gas. As shown in FIG. 2, the spiral-wound membrane element (5) consists of a separation membrane (18), a feed-side spacer (16), a permeate-side spacer (17), and a permeate tube (12), with an effective area of 31 m2. Seven spiral-wound membrane elements (5) are installed in the membrane housing (13), providing a total effective membrane area of 217 m2. The spiral-wound membrane elements (5) are arranged within the membrane housing (13) as shown in the sectional view in FIG. 5, B-B. The membrane housing (13) is equipped with interfaces serving as the feed gas interface (3) and the retentate gas interface (11). Both ends of the membrane housing (13) are connected to the end cap (10). The end cap (10) is fitted with a permeate gas interface (1). An open holed perforated plate (2) is positioned between the membrane housing (13) and the end cap (10). The gas permeate tube (12) of the spiral-wound membrane element directly inserts into the openings of the perforated plate (2) to isolate the permeate gas from the feed gas and the retentate gas. A gas permeate tube sealing ring (7) is placed at the connection point between the gas permeate tube (12) and the openings of the perforated plate (2) to prevent leakage of the permeate gas from the permeate tube and to avoid contamination of the permeate gas by the feed gas and the retentate gas entering the permeate tube and the end cap. Flange joints are fitted at the ends of the membrane housing (13) and the end cap (10) of the membrane separator, with each part being detachably connected via flanges, gaskets, and bolts.

A CO2/N2/H2O mixed gas (25° C., with a CO2/N2 volume ratio of 14/86 and the saturated water vapor) is fed into the feed gas interface (3) of the multi-element membrane separator, simulating the CO2 capture process of flue gas from a coal-fired power plant. The pressures of the retentate gas at the retentate gas interface (11) are maintained at 0.5, 0.3, and 0.15 MPa (absolute pressure, the same below), and the pressures of the permeate gas at the permeate gas interface (1) are maintained at 0.1, 0.06, and 0.03 MPa, as shown in Table 1.

### Embodiment 2

On the basis of Embodiment 1, this embodiment further optimizes the module and rapid assembly of the membrane separator, as follows:

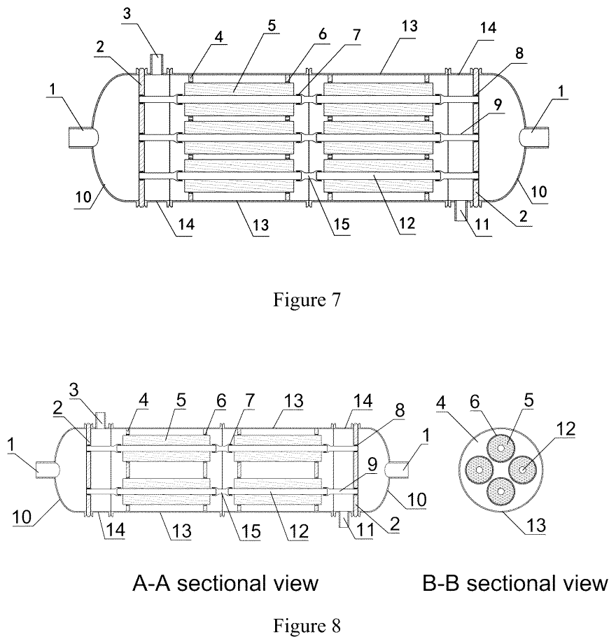

Referring to FIGS. 6 to 7, the multi-element membrane separator based on a spiral-wound membrane element includes a membrane housing (13), a membrane housing with an opening (14), a perforated plate (2), and an end cap (10). Baffles (4) are provided on both sides of the membrane housing (13) to secure the spiral-wound membrane element (5). A membrane element sealing ring (6) is placed between the baffles (4) and the spiral-wound membrane element (5) to prevent short-circuiting of the feed gas within the membrane separator and direct entry into the retentate gas.

As shown in FIG. 2, the spiral-wound membrane element (5) consists of a separation membrane (18), feed-side spacers (16), permeate side spacers (17), and a permeate tube (12), with an effective area of 31 m2. Seven spiral-wound membrane elements (5) are installed within the membrane housing (13), providing a total effective membrane area of 217 m2. The two membrane housings (13) are connected together by flange joints, with both ends connected to the membrane housing with an opening (14), the perforated plate (2), and the end cap (10), achieving the modular assembly of a larger membrane area membrane separator. The gas permeate tubes (12) between the two membrane housings (13) are connected via permeate tube-permeate tube connector (15). Permeate tube sealing ring (7) are placed at the connection points between the gas permeate tube (12) and the permeate tube-permeate tube connector (15) to prevent leakage of the permeate gas and contamination of the permeate gas by the feed gas and the retentate gas entering the gas permeate tube.

The other end of the membrane housing (13) is connected to the membrane housing with an opening (14). The membrane housing with an opening (14) is equipped with interfaces serving as the feed gas interface (3) or the retentate gas interface (11). The other end of the membrane housing with an opening (14) is connected to the end cap (10). The end cap (10) is fitted with a permeate gas interface (1). An open holed perforated plate (2) is placed between membrane housing with an opening (14) and the end cap (10). The other end of the permeate tube (12) is inserted into the openings of the perforated plate (2) through a gas permeate tube to perforated plate connector (9) to isolate the permeate gas from the feed gas and the retentate gas. Sealing rings (7) and (8) are placed at the connection points between the gas permeate tube (12) and the permeate tube-perforated plate connector (9), and between the permeate tube-perforated plate connector (9) and the perforated plate (2) to prevent leakage of the permeate gas from the gas permeate tube and the perforated plate. Flange joints are provided at the ends of the membrane housing (13), the membrane housing with an opening (14), and the end cap (10) of the membrane separator, with each part being detachably connected via flanges, gaskets, and bolts. The membrane separator, composed of the two connected membrane housings, can accommodate 14 spiral-wound membrane elements, providing an effective membrane area of 434 m2.

A CO2/N2/H2O mixed gas (25° C., with a CO2/N2 volume ratio of 14/86 and a water content at the saturation water vapor level) is fed into the feed gas interface (3) of the multi-element membrane separator, simulating the CO2 capture process of flue gas from a coal-fired power plant. The pressure of the retentate gas at the retentate gas interface (11) is maintained at 0.5 MPa, while the pressure of the permeate gas at the permeate gas interface (1) is 0.1 MPa. Referring to Table 1 for the test results.

### Embodiment 3

This embodiment is adjusted based on Embodiment 2, as follows:

Referring to FIG. 8, the effective membrane area of the spiral-wound membrane element (5) is 25 m2. Four spiral-wound membrane elements (5) are installed within the membrane housing (13), providing a total effective membrane area of 100 m2. The membrane separator, composed of the two connected membrane housings, can accommodate eight spiral-wound membrane elements, resulting in an effective membrane area of 200 m2.

A CO2/N2/H2O mixed gas (25° C., with a CO2/N2 volume ratio of 14/86 and a water content at the saturation water vapor level), simulating the CO2 capture process of flue gas from a coal-fired power plant, is fed into the feed gas interface (3) of the multi-element membrane separator. The pressure of the retentate gas at the retentate gas interface (11) is maintained at 0.5 MPa, while the pressure of the permeate gas at the permeate gas interface (1) is 0.1 MPa. Referring to Table 1 for the test results.

Test Data and Conclusions

In the above examples, for the multi-element membrane separator involved in the present invention, the experimental results under different conditions such as retentate gas pressure, permeate gas pressure and number of spiral wound membrane elements were investigated, as shown in the table below.

TABLE 1
Experimental results of Embodiment 1-3 of the multi-element membrane
separator of the present invention under different conditions

| Embodiment | 1 | | | 2 | 3 |
|---|---|---|---|---|---|
| Number of membrane elements (pieces) | 7 | | | 14 | 8 |
| Total effective membrane area (m²) | 217 | | | 434 | 200 |
| Feed gas flowrate (Nm³/h) | 125 | | | 250 | 115 |
| Feed gas pressure (MPa) | 0.504 | / | / | 0.515 | 0.513 |
| Retentate gas pressure (MPa) | 0.500 | 0.300 | 0.150 | 0.500 | 0.500 |
| Feed side pressure drop ¹ (MPa) | 0.004 | / | / | 0.015 | 0.013 |
| Permeate gas pressure (MPa) | 0.100 | 0.060 | 0.030 | 0.100 | 0.100 |
| Permeate gas CO₂ content | 36.3% | 44.5% | 51.0% | 37.0% | 36.7% |
| CO₂ recovery rate ² | 67.8% | 50.6% | 27.5% | 66.9% | 67.1% |

Note:
¹ Feed side pressure drop = feed gas pressure − retentate gas pressure;
² CO₂ recovery rate = permeate gas flow × permeate gas CO₂ content/(feed gas flow × feed gas CO₂ content).

According to Table 1, the multi-element membrane separator designed in this invention demonstrates excellent separation results. Under a retentate gas pressure of 0.5 MPa, the 7-element membrane separator proposed in Example 1 processes a feed gas flowrate of 125 Nm3/h, achieving a high CO2 recovery rate of 67.8%. As the pressure gradually decreases, the CO2 recovery rate decreases, but the CO2 content in the permeate gas increases. Under a retentate gas pressure of 0.3 MPa, the CO2 recovery rate of the 7-element membrane separator drops to 50.6%, while the CO2 content in the permeate gas increases to 44.5%. Further reducing the retentate gas pressure to 0.15 MPa increases the CO2 content in the permeate gas to 51.0%. The experimental results shown in Embodiment 1 demonstrate that the multi-element membrane separator designed in this invention exhibits excellent separation performance at different operating pressures, making it suitable for various separation tasks. Under a retentate gas pressure of 0.5 MPa, the 14-element membrane separator proposed in Embodiment 2 processes a feed gas flowrate of 250 Nm3/h, ensuring a consistent processing capacity per unit membrane area compared to Embodiment 1 (i.e., an average of 0.576 Nm3/h feed gas per square meter of separation membrane). The CO2 recovery rate is 66.9%, which is 1.3% lower than the CO2 recovery rate in Embodiment 1, and the CO2 content in the permeate gas slightly increases. The feed side pressure drop of the 7-element membrane separator proposed in Embodiment 1 is only 0.004 MPa, while the pressure drop of the 14-element membrane separator proposed in Embodiment 2, although increased to 0.015 MPa, accounts for only 2.9% of the feed gas pressure, making the impact on operating energy consumption negligible. Furthermore, Embodiments 2 and 3 are both membrane separators composed of two connected membrane housings, and the experimental results of Embodiments 2 and 3 are essentially the same. These results confirm that the multi-element membrane separator designed in this invention has the advantages of high separation efficiency, low pressure loss, and the feasibility of modular assembly.

The solutions and devices disclosed and proposed by the present invention can be realized by researchers in the field by referring to the contents of this article and appropriately changing the parameters. Although the method and equipment of the present invention have been described through preferred implementation examples, relevant technical personnel can obviously realize it without departing from the methods and equipment described herein can be modified or recombined within the content, spirit and scope of the present invention to achieve the final preparation technology. In particular, it should be noted that all similar substitutions and modifications that are obvious to researchers in the art are deemed to be included in the spirit, scope and content of the present invention.

1. A multi-element membrane separator based on spiral-wound membrane elements, comprising a membrane housing and spiral-wound membrane elements; wherein, baffles placed on both sides of the membrane housing to secure the spiral-wound membrane elements; at least three spiral-wound membrane elements are arranged inside the membrane housing; wherein, the membrane housing can be connected to an end cap or another membrane housing, or connected to a membrane housing with an opening, and the membrane housing with an opening is connected to an end cap, wherein, the membrane housing or membrane housing with an opening is equipped with interfaces serving as feed gas interfaces or retentate gas interfaces.

2. The multi-element membrane separator based on spiral-wound membrane elements, as claimed in claim 1, wherein, perforated plates are placed between the membrane housing and the end cap, or between the membrane housing with an opening and the end cap; wherein, the permeate tubes of the spiral-wound membrane elements are connected to the openings in the perforated plates; sealing rings are respectively provided at the connections of the permeate tube and the perforated plate openings.

3. The multi-element membrane separator based on spiral-wound membrane elements, as claimed in claim 1, wherein, the ends of the membrane housing, membrane housing with an opening, and end cap of the multi-elementt membrane separator are equipped with flange joints; wherein, the various parts of the membrane separator can be detachably connected via flanges, gaskets, and bolts.

4. The multi-element membrane separator based on spiral-wound membrane elements, as claimed in claim 1, wherein, the spiral-wound membrane elements composed of separation membranes, feed-side spacers, permeate-side spacers, and permeate tube.

5. The method of the multi-element membrane separator based on spiral-wound membrane elements, as claimed in claim 1, further including the following steps: the raw gas to be separated flows into the membrane separator through the feed gas interface, then enters the feed channel formed by the feed-side spacer within the membrane element; gas components with fast permeation rates preferentially permeate through the membrane under the driving force of the pressure difference, entering the permeate channel formed by the permeate-side spacer, and converging into the perforated permeate tube, wherein, the gas components are finally collected as permeate gas and flow out of the membrane separator through the permeate gas interface; wherein, the gas components with slower permeation rates mostly fail to permeate through the membrane and exit from the other side of the feed channel of the membrane element; wherein, the gas components are finally collected as retentate gas and flow out of the membrane separator through the retentate gas interface.
